(19) United States
(12) Patent Application Publication
(10) Pub. No.: US 2022/0182964 A1
(43) Pub. Date: Jun. 9, 2022

(54) NETWORK PRESENCE DETECTION

(71) Applicant: ARRIS Enterprises LLC, Suwanee, GA (US)

(72) Inventor: David F. BRUMBAUGH, Collegeville, PA (US)

(21) Appl. No.: 17/485,774

(22) Filed: Sep. 27, 2021

Related U.S. Application Data
(60) Provisional application No. 63/123,125, filed on Dec. 9, 2020.

(51) Int. Cl. H04W 60/02; H04W 4/02; H04W 24/08; H04W 60/06; H04W 48/18

(52) U.S. Cl. CPC H04W 60/02; H04W 4/02; H04W 48/18; H04W 60/06; H04W 24/08

(57) ABSTRACT

Aspects of the present disclosure are drawn to a client device for use with a Wi-Fi network device, a second client device, and a third client device. The Wi-Fi network device has a host table stored therein. The host table lists the second client device and the third client device. The client device is able to associate with the Wi-Fi network device, identify the second client device, and identify the third client device. The client device also creates a monitored devices list of client devices associated with the Wi-Fi network based on the host table. The client device also adds the second client device to the monitored devices list and determines, from the host table, whether the second client device is currently associated with the Wi-Fi network device. The client device additionally provides an indication when the second client device is currently associated with the Wi-Fi network device.

### BACKGROUND

Embodiments of the present disclosure relate to wireless network management and monitoring.

### SUMMARY

Aspects of the present disclosure are drawn to a client device for use with a Wi-Fi network device, a second client device and a third client device. The Wi-Fi network device has a host table which lists the second client device, second client device presence information indicating whether the second client device is currently associated with the Wi-Fi network device, and the third client device. The client device includes: a memory and a processor configured to execute instructions stored on the memory causing the client device to associate with the Wi-Fi network device; identify the second client device; identify the third client device; create a monitored devices list of client devices associated with the Wi-Fi network device based on the host table; add the second client device to the monitored devices list; determine, from the host table, whether the second client device is currently associated with the Wi-Fi network device; and provide an indication when the second client device is currently associated with the Wi-Fi network device.

In some embodiments, the processor is configured to execute instructions stored on the memory to cause the client device additionally to indicate, in a state where the second client device is associated with the Wi-Fi network device, time information related to when the second client device associated with the Wi-Fi network device.

In some embodiments, the processor is configured to execute instructions stored on the memory to cause the client device additionally to indicate, in a state where the second client device is not associated with the Wi-Fi network device, time information related to when the second client device disassociated with the Wi-Fi network device.

In some embodiments, the processor is configured to execute instructions stored on the memory to cause the client device additionally to: not add the third client device to the monitored devices list; not determine whether the third client device is currently associated with the Wi-Fi network device; and not provide an indication when the third client device is currently associated with the Wi-Fi network device.

In some embodiments, the processor is configured to execute instructions stored on the memory to cause the client device additionally to: establish a time range; associate the second client device with the time range; and determine, from the host table, whether the second client device has associated with the Wi-Fi network device within the time range. In some of these embodiments, the processor is configured to execute instructions stored on the memory to cause the client device additionally to provide an indication when the second client device has not associated with the Wi-Fi network device within the time range.

Other aspects of the present disclosure are drawn to a method of using a client device with a Wi-Fi network device, a second client device and a third client device. The Wi-Fi network device has a host table stored which lists the second client device, second client device presence information indicating whether the second client device is currently associated with the Wi-Fi network device, and the third client device. The method includes associating, via a processor configured to execute instructions stored on a memory, with the Wi-Fi network device; identifying, via the processor, the second client device; identifying, via the processor, the third client device; creating, via the processor, a monitored devices list of client devices associated with the Wi-Fi network device based on the host table; adding, via the processor, the second client device to the monitored devices list; determining, via the processor and from the host table, whether the second client device is currently associated with the Wi-Fi network device; and providing, via the processor, an indication when the second client device is currently associated with the Wi-Fi network device.

In some embodiments, the method further includes indicating, via the processor and in a state where the second client device is associated with the Wi-Fi network device, time information related to when the second client device associated with the Wi-Fi network device.

In some embodiments, the method further includes indicating, via the processor and in a state where the second client device is not associated with the Wi-Fi network device, time information related to when the second client device disassociated with the Wi-Fi network device.

In some embodiments, the method further includes not adding, via the processor, the third client device to the monitored devices list; not determining, via the processor, whether the third client device is currently associated with the Wi-Fi network device; and not providing, via the processor, an indication when the third client device is currently associated with the Wi-Fi network device.

In some embodiments, the method further includes: establishing, via the processor, a time range; associating, via the processor, the second client device with the time range; and determining, via the processor and from the host table, whether the second client device has associated with the Wi-Fi network device within the time range. In some of these embodiments, the method further includes providing, via the processor, an indication when the second client device has not associated with the Wi-Fi network device within the time range.

Other aspects of the present disclosure are drawn to a non-transitory, computer-readable media having computer-readable instructions stored thereon; the computer-readable instructions being capable of being read by a processor in a client device for use with a Wi-Fi network device and a second client device. The Wi-Fi network device has a host table stored therein, the host table listing the second client device, second client device presence information indicating whether the second client device is currently associated with the Wi-Fi network device, and the third client device, wherein the computer-readable instructions are capable of instructing the processor to perform the method including associating, via a processor configured to execute instructions stored on a memory, with the Wi-Fi network device; identifying, via the processor, the second client device; identifying, via the processor, the third client device; creating, via the processor, a monitored devices list of client devices associated with the Wi-Fi network device based on the host table; adding, via the processor, the second client device to the monitored devices list; determining, via the processor and from the host table, whether the second client device is currently associated with the Wi-Fi network device; and providing, via the processor, an indication when the second client device is currently associated with the Wi-Fi network device.

In some embodiments, the computer-readable instructions are capable of instructing the processor to perform the method further including indicating, via the processor and in a state where the second client device is associated with the Wi-Fi network device, time information related to when the second client device associated with the Wi-Fi network device.

In some embodiments, the computer-readable instructions are capable of instructing the processor to perform the method further including indicating, via the processor and in a state where the second client device is not associated with the Wi-Fi network device, time information related to when the second client device disassociated with the Wi-Fi network device.

In some embodiments, the computer-readable instructions are capable of instructing the processor to perform the method further including not adding, via the processor, the third client device to the monitored devices list; not determining, via the processor, whether the third client device is currently associated with the Wi-Fi network device; and not providing, via the processor, an indication when the third client device is currently associated with the Wi-Fi network device.

In some embodiments, the computer-readable instructions are capable of instructing the processor to perform the method further including: establishing, via the processor, a time range; associating, via the processor, the second client device with the time range; and determining, via the processor and from the host table, whether the second client device has associated with the Wi-Fi network device within the time range. In some of these embodiments, the computer-readable instructions are capable of instructing the processor to perform the method further including providing, via the processor, an indication when the second client device has not associated with the Wi-Fi network device within the time range.

### BRIEF SUMMARY OF THE DRAWINGS

The accompanying drawings, which are incorporated in and form a part of the specification, illustrate example embodiments and, together with the description, serve to explain the principles of the present disclosure. In the drawings:

FIG. 1 illustrates a conventional communication system at a time to;

FIG. 2A illustrates a communication system in accordance with aspects of the present disclosure at a time t₁;

FIG. 2B illustrates a communication system in accordance with aspects of the present disclosure at a time t₂;

FIG. 3 illustrates an algorithm to be executed by a processor for determining whether a client device is currently associated with a Wi-Fi network device, in accordance with aspects of the present disclosure;

FIG. 4 illustrates an exploded view of a client device, gateway device, and external server as shown in FIGS. 2A-B;

FIG. 5 illustrates a non-limiting example of a host table stored in a Wi-Fi network device;

FIG. 6A illustrates a non-limiting example of a graphic user interface (GUI), at a time t₃, in accordance with aspects of the present disclosure;

FIG. 6B illustrates a non-limiting example of a GUI at a time t₄, in accordance with aspects of the present disclosure; and

FIG. 7 illustrates another algorithm to be executed by a processor for determining whether a client device has associated with a Wi-Fi network device within an established time range, in accordance with aspects of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

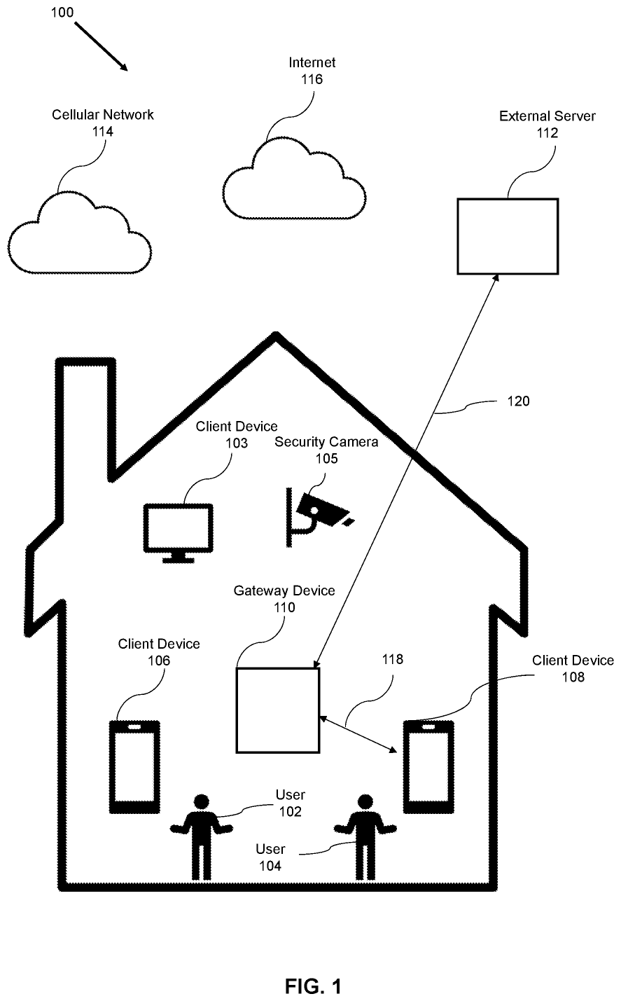

FIG. 1 illustrates a conventional communication system 100 at time to.

As shown in the figure, communication system 100 includes a user 102, a user 104, a client device 103, a security camera 105, a client device 106, a client device 108, a gateway device 110, an external server 112, a cellular network 114, an Internet 116, a communication channel 118, and a communication channel 120.

As shown in the figure, client device 108 is configured to communicate with gateway device 110 via communication channel 118. Through gateway device 110, client device 108 is able to communicate with external server 112 via communication channel 120.

Gateway device 110 is configured to communicate with Internet 116 by way of physical media/wiring (not shown).

As illustrated in FIG. 1, gateway device 110, also referred to as a gateway, residential gateway, or RG, is an electronic device that is to be located so as to establish a local area network (LAN) at a consumer premises. The consumer premises can include a residential dwelling, office, or any other business space of a user. The terms home, office and premises may be used synonymously herein.

Gateway device 110 may be any device or system that is operable to allow data to flow from one discrete network to another, which, in this example, is from a wireless local area network (WLAN) to an external network, e.g., Internet 116. Gateway device 110 may perform such functions as web acceleration and HTTP compression, flow control, encryption, redundancy switchovers, traffic restriction policy enforcement, data compression, TCP performance enhancements (e.g., TCP performance enhancing proxies, such as TCP spoofing), quality of service functions (e.g., classification, prioritization, differentiation, random early detection (RED), TCP/UDP flow control), bandwidth usage policing, dynamic load balancing, and routing.

Gateway device 110 establishes, or is part of a WLAN, using Wi-Fi for example, such that client device 108 is able to communicate wirelessly with gateway device 110. The term Wi-Fi as used herein may be considered to refer to any of Wi-Fi 4, 5, 6, 6E, or any variation thereof.

Further, it should be noted that gateway device 110 is able to communicate with Internet 116 via physical media/wiring, which may optionally be a wireless communication system, such as 4G or 5G, and further is able to connect to the external network, e.g., Internet 116, via a service provider.

Within the WLAN, electronic devices are often referred to as being stations. In IEEE 802.11 (Wi-Fi) terminology, a station (abbreviated as STA) is a device that has the capability to use the 802.11 protocol. For example, a station may be a laptop, a desktop PC, PDA, access point device (APD) or Wi-Fi phone. An STA may be fixed, mobile or portable. Generally, in wireless networking terminology, a station, wireless client, and node are often used interchangeably, with no strict distinction existing between these terms. A station may also be referred to as a transmitter or receiver based on its transmission characteristics. IEEE 802.11-2012 defines station as: A logical entity that is a singly addressable instance of a medium access control (MAC) and physical layer (PHY) interface to the wireless medium (WM).

For purposes of discussion, consider the following situation. User 104 wants to monitor if their child, user 102, is using a device associated with gateway device 110. In this example, user 104 wants to see if client device 106 is being used. However, user 104 has many devices connected to gateway device 110, including client device 103, security camera 105, client device 106, and client device 108. If this check needed to be quick, for example, in the case of an emergency or because of security concerns, it may be aggravating to user 104 to scroll through the many devices they have connected to gateway device 110. Also, user 104 could not use this method to quickly see if a non-familiar device has been connected to gateway device 110. Additionally, user 104 may not know how long a device has been connected or disconnected from gateway device 110. These factors not only pose a threat to security in the user's home, but also show flaws in usability that could be corrected to be more user friendly.

What is needed is a system and method for displaying devices associated or disassociated with a network device as well as having the ability to customize what devices are being monitored.

A system and method in accordance with the present disclosure provides a means of detecting users associated or disassociated with a network device with no additional equipment beyond a network device and client device.

In accordance with the present disclosure, the utilization of the network device's client detection along with a unique client device user interface allows for easy display of when people are present or absent in a residence as well as how long they have been present or absent from the residence based on the network status of each person's client device. The network device has the ability to detect when a client device is associated or disassociated from the network. The network device maintains this status in the host table as device present information. In particular, the host table lists device presence information indicating whether a client device currently associated with the network device.

Further, in some embodiments, the device presence information may include how long a client device has been associated with the network device in those cases where the client device is associated with the network device. Still further, in some embodiments, the device presence information may include how long a client device has been disassociated from the network device in those cases where the client device has disassociated with the network device.

Each client devices is identified within the network device by its MAC address and its host name. The user is able to change this to a more familiar form using their client device. The user may create a “friendly name” for each device. For example, the device with the MAC address of E8:B2:AC:D4:92:5F may be named “Dave's Phone”, and this friendly name is held persistent in the user's account. This allows the user to establish names for each of the client devices within the home network. The user will be offered the ability to configure the home monitoring by selecting the devices they wish to add to a “Who's Home” user interface. The client device will offer a setup screen allowing the user to select the devices to be monitored. This selection screen is not shown. When the user begins home monitoring, the client device will read the status for the client devices connected to the network device on a periodic basis. A device status of active will indicate the associated user is in the residence. At any point, the client device user can bring up the monitoring page to see who is associated with the network device. Various methods and user interfaces (UIs) may be used for this status indication. In some embodiments, a UI displays only the associated or at home devices. Other embodiments may show user interfaces with a green or red indicator for each monitored device, with green showing the device was associated successfully and red showing there was an issue with associating the device. These are non-limiting examples of just a few options for displaying each monitored device. This monitoring can include a variety of contact devices, motion detectors, and cameras. However, one of the simplest use cases is to know who is associated with the network device and how long they have been associated. This detection and display method resolves this use case without any additional equipment.

One benefit of this invention is the use of the client device associated/disassociated or home/not home status to provide a simple and straightforward manner to monitor what devices are connected. Additionally, the simple user interface to display if someone is home or away, along with their duration time, allows for easy monitoring. Both allow for increased security and monitoring of who is in the home and what devices are connected to the gateway device. Another benefit of this invention is the ability to monitor a residence without having to purchase any additional equipment since this can all be done with the use of the client device as well as the network device.

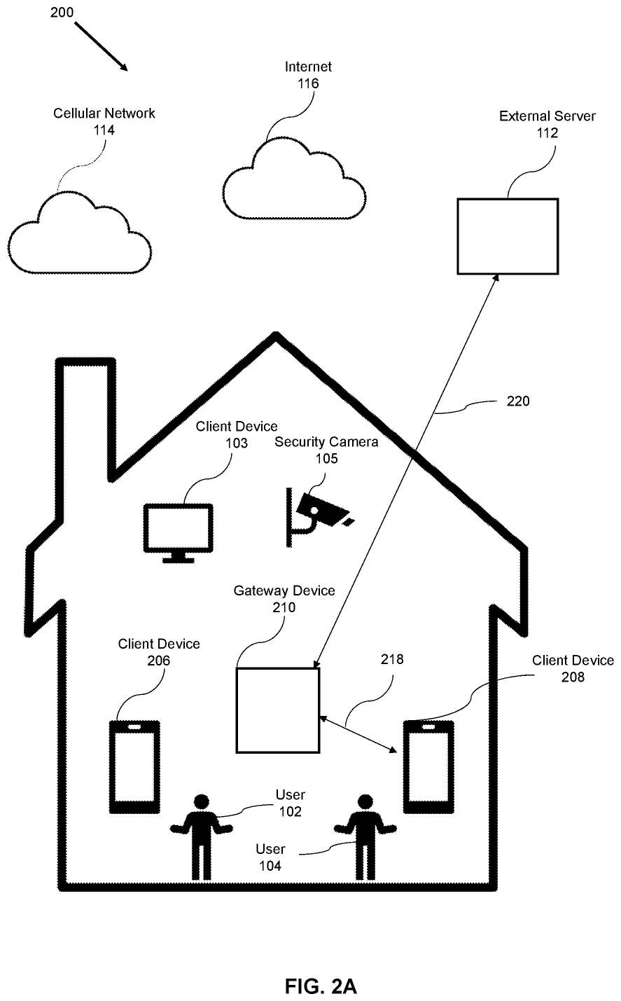

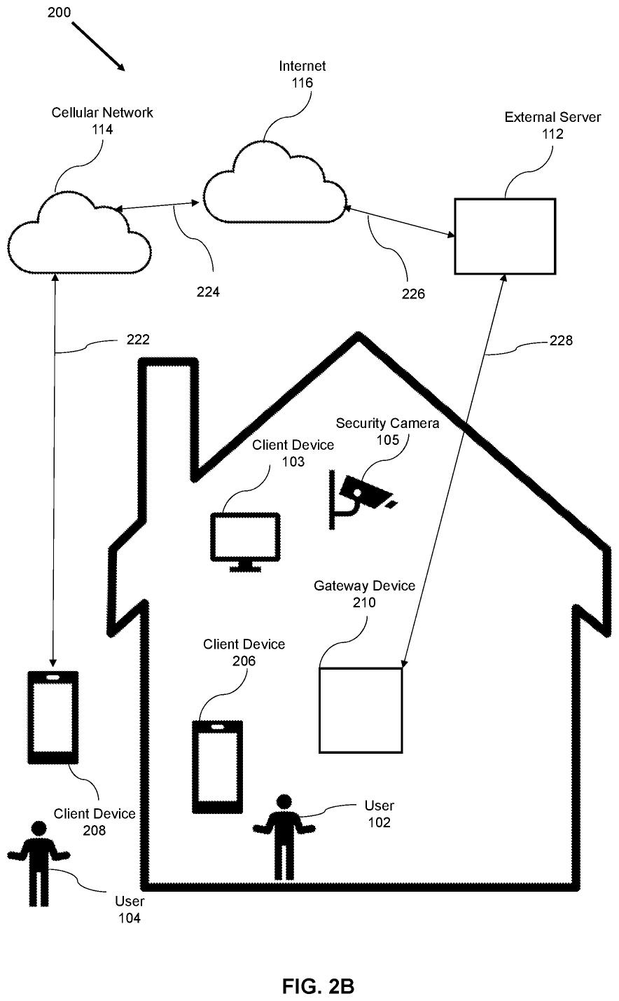

An example system and method for determining client device association in accordance with aspects of the present disclosure will now be described in greater detail with reference to FIGS. 2A-6B.

FIG. 2A illustrates a communication system 200 in accordance with aspects of the present disclosure at a time t₁.

As shown in the figure, communication system 200 includes a client device 206, a client device 208, a gateway device 210, user 102, user 104, client device 103, security camera 105, external server 112, cellular network 114, Internet 116, a communication channel 218, and a communication channel 220.

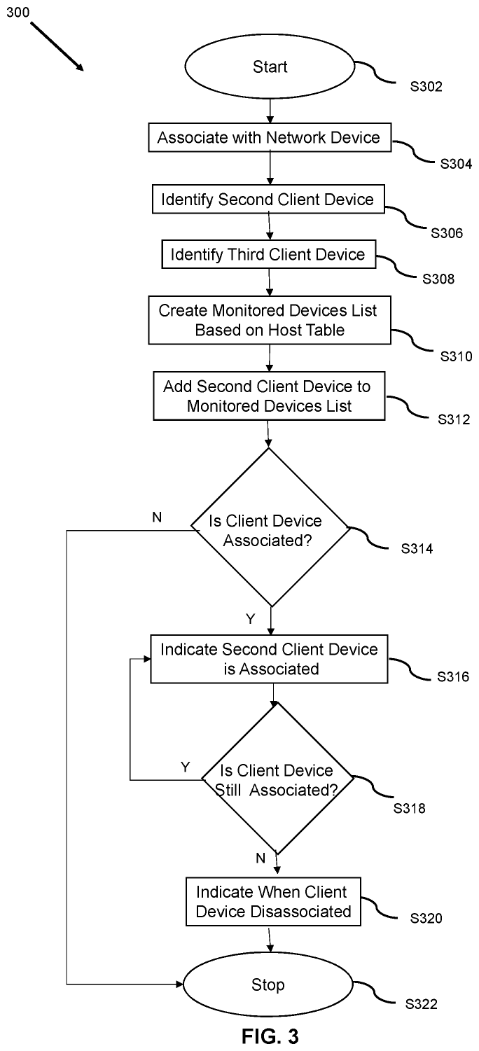

Consider the example situation wherein user 104 is attempting to monitor the devices in their residence using client device 208. This will be described in greater detail with reference to FIG. 3.

FIG. 3 illustrates an algorithm 300 to be executed by a processor for determining if a client device is currently associated with the Wi-Fi network device, in accordance with aspects of the present disclosure.

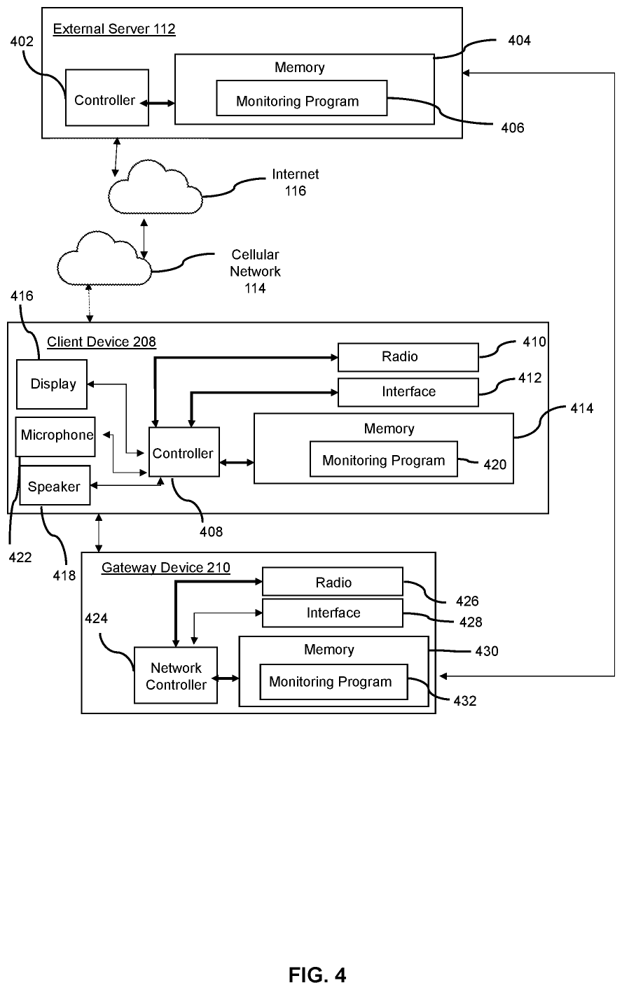

As shown in the figure, algorithm 300 starts (S302), and the client device associates with the network device (S304). An example embodiment will be described in greater detail with reference to FIGS. 2A and 4.

FIG. 4 illustrates an exploded view of client device 208, gateway device 210, and external server 112, and Internet 116, and cellular network 114 as shown in FIGS. 2A-B;

As shown in the figure, gateway device 210 includes: a network controller 424, a memory 430, which has stored therein a monitoring program 432; at least one radio, a sample of which is illustrated as a radio 426, and an interface circuit 428.

In this example, network controller 424, memory 430, radio 426, and interface circuit 428 are illustrated as individual devices. However, in some cases, at least two of network controller 424, memory 430, radio 426 and interface circuit 428 may be combined as a unitary device. Whether as individual devices or as combined devices, network controller 424, memory 430, radio 426, and interface circuit 428 may be implemented as any combination of an apparatus, a system and an integrated circuit. Further, in some embodiments, at least one of network controller 424, memory 430, and interface circuit 428 may be implemented as a computer having a non-transitory computer-readable recording medium. A non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from, and write information to the tangible computer-readable media. In the alternative, the tangible computer-readable media may be integral to the processor. The processor and the tangible computer-readable media may reside in an integrated circuit (IC), an application specific integrated circuit (ASIC), or large scale integrated circuit (LSI), system LSI, super LSI, or ultra LSI components that perform a part or all of the functions described herein. In the alternative, the processor and the tangible computer-readable media may reside as discrete components.

Example tangible computer-readable media may also be coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules maybe located in both local and remote computer system storage media including memory storage devices.

Components of an example computer system/server may include, but are not limited to, one or more processors or processing units, a system memory, and a bus that couples various system components including the system memory to the processor.

A program/utility, having a set (at least one) of program modules, may be stored in the memory by way of example, and not limitation, as well as an operating system, one or more application programs, other program modules, and program data or some combination thereof, may include an implementation of a networking environment. The program modules generally carry out the functions and/or methodologies of various embodiments of the application as described herein.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Network controller 424 can include a dedicated control circuit, CPU, microprocessor, etc. Network controller 424 controls the circuits of gateway device 210. Memory 430 can store various programming, and user content, and data including monitoring program 432. Monitoring program 432 includes instructions, that when executed by network controller 424 enables gateway device 210 to enable client device 208 to initiate monitoring on gateway device 210.

Interface circuit 428 can include one or more connectors, such as RF connectors, or Ethernet connectors, and/or wireless communication circuitry, such as 5G circuitry and one or more antennas. Interface circuit 428 receives content from external server 112 (as shown in FIG. 4) by known methods, non-limiting examples of which include terrestrial antenna, satellite dish, wired cable, DSL, optical fibers, or 5G as discussed above. Through interface circuit 428, gateway device 210 receives an input signal, including data and/or audio/video content, from external server 112 and can send data to external server 112.

Radio 426 (and preferably two or more radios), may also be referred to as a wireless communication circuit, such as a Wi-Fi WLAN interface radio transceiver and is operable to communicate with client device 103, client device 206, client device 208, security camera 105, and external server 112. Radio 426 includes one or more antennas and communicates wirelessly via one or more of the 2.4 GHz band, the 5 GHz band, the 6 GHz band, and the 60 GHz band, or at the appropriate band and bandwidth to implement the Wi-Fi 4, 5, 6, or 6E protocols. Gateway device 110 can also be equipped with a radio to implement a Bluetooth interface radio transceiver and antenna, which communicates wirelessly in the ISM band, from 2.400 to 2.485 GHz. As an alternative, at least one of the radios can be a radio meeting a Radio Frequency for Consumer Electronics (RF4CE) protocol, ZigBee protocol, and/or IEEE 802.15.4 protocol, which also communicates in the ISM band.

External server 112 includes: a controller 402 and a memory 404, which has stored therein a monitoring program 406.

Controller 402 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of external server 112 in accordance with the embodiments described in the present disclosure.

Memory 404 can store various programming, and user content, and data including monitoring program 406. Monitoring program 406 includes instructions, that when executed by controller 402 enables client device 208 to initiate monitoring on gateway device 210.

Client device 208 includes: a controller 408; a memory 414, which has stored therein a monitoring program 420; and at least one radio, a sample of which is illustrated as a radio 410; an interface circuit 412, a display 416, microphone 422, and a speaker 418.

In this example, controller 408, memory 414, radio 410, interface circuit 412, display 416, and speaker 418 are illustrated as individual devices. However, in some cases, at least two of controller 408, memory 414, radio 410, interface circuit 412, display 416, and speaker 418 may be combined as a unitary device. Further, in some cases, at least one of controller 408 and memory 414 may be implemented as a computer having tangible computer-readable media for carrying or having computer-executable instructions or data structures stored thereon.

As will be described in greater detail below, controller 408 is configured to execute instructions stored in memory 414 to cause client device 208 to associate with gateway device 210; identify the second client device; identify the third client device; create a monitored devices list of client devices associated with gateway device 210 based on the host table; add the second client device to the monitored devices list; determine, from the host table, whether the second client device is currently associated with gateway device 210; and provide an indication when the second client device is currently associated with gateway device 210.

As will be described in greater detail below, in some embodiments, controller 408 is also configured to execute instructions stored in memory 414 to cause client device 208 additionally to indicate, in a state where the second client device is associated with gateway device 210, time information related to when the second client device associated with gateway device 210.

As will be described in greater detail below, in some embodiments, controller 408 is additionally configured to execute instructions stored in memory 414 to cause client device 208 to further indicate, in a state where the second client device is not associated with gateway device 210, time information related to when the second client device disassociated with gateway device 210.

As will be described in greater detail below, in some embodiments, controller 408 is configured to execute instructions stored in memory 414 to cause client device 208 to not add the third client device to the monitored devices list; not determine whether the third client device is currently associated with gateway device 210; and not provide an indication when the third client device is currently associated with gateway device 210.

As will be described in greater detail below, in some embodiments, controller 408 is configured to execute instructions stored in memory 414 to cause client device 208 to: establish a time range; associate the second client device with the time range; and determine, from the host table, whether the second client device has associated with gateway device 210 within the time range. As will be described in greater detail below, in some of these embodiments, controller 408 is configured to execute instructions stored in memory 414 to additionally cause client device 208 to provide an indication when the second client device has not associated with gateway device 210 within the time range.

Controller 408, which can include a dedicated control circuit, CPU, microprocessor, etc., controls the circuits of client device 208.

Memory 414 can store various programming, and user content, and data including monitoring program 420. Monitoring program 420 includes instructions, that when executed by controller 408 enables client device 208 to initiate monitoring on gateway device 210.

Interface circuit 412 can include one or more connectors, such as RF connectors, or Ethernet connectors, and/or wireless communication circuitry, such as 5G circuitry and one or more antennas. Interface circuit 412 enables a user (not shown) to interface with controller 408 to manually operate or configure client device 208. Interface circuit 412 further enables controller 408 to decode communication signals received by radio 410 from gateway device 210 and to encode communication signals to be transmitted by radio 410 to gateway device 210.

Radio 410, may include a Wi-Fi WLAN interface radio transceiver that is operable to communicate with gateway device 210, as shown in FIGS. 2A and B, and also may include a cellular transceiver operable to communicate with a cellular service provider (not shown) through a cellular network. Radio 410 includes one or more antennas and communicates wirelessly via one or more of the 2.4 GHz band, the 5 GHz band, 6 GHz band, and the 60 GHz band, or at the appropriate band and bandwidth to implement the Wi-Fi 4, 5, 6, or 6E protocols. Client device 208 can also be equipped with a radio to implement a Bluetooth interface radio transceiver and antenna, which communicates wirelessly in the ISM band, from 2.400 to 2.485 GHz. As an alternative, at least one of the radios can be a radio meeting a Radio Frequency for Consumer Electronics (RF4CE) protocol, ZigBee protocol, and/or IEEE 802.15.4 protocol, which also communicates in the ISM band.

Insofar as gateway device 210 provides connection to external server 112, such as a multiple systems operator (MSO), gateway device 210 can be equipped with connectors to connect with a television or display device, and can also include programming to execute an electronic program guide and/or other suitable graphical user interface (GUI), and can with such configuration be referred to as a so called set top box. Such a set top box can be included in the system shown in FIG. 2A as gateway device 210 or in addition thereto. Moreover, inclusion of one or more of far-field microphones, (for e.g., voice command and/or presence recognition, and/or telephone communication), cameras, (for e.g., gesture and/or presence recognition, and/or video telephone communication), and speakers, and associated programming, can enable the gateway device to be a so called smart media device.

In the non-limiting example discussed above, the gateway device is described as being configured to communicate through the internet by way of the service provider server with the external server. However, it should be noted that in some cases, the service provider server may include the external server in accordance with aspects of the present disclosure.

For purposes of discussion, consider the following situation, with reference to FIG. 2A, in which user 104 is attempting to associate or onboard client device 208 onto gateway device 210. With reference to FIG. 4, network controller 424 will broadcast an onboarding SSID by way of radio 426. Radio 410 will detect the Wi-Fi SSID from gateway device 210 and user 104 will provide the password. This password will then be broadcast by radio 410 and gateway device 210 will receive the password by way of radio 426. Then, there is a handshake between gateway device 210 and client device 208 and client device 208 will then be onboarded, or associated, with gateway device 210. Once client device 208 is associated, gateway device 210 will add this to a host table stored within memory 430 to indicate that client device 208 is now associated. Additionally, any further devices that are associated in a similar manner to client device 208 will also be added to the host table stored within memory 430 to indicate association.

Returning to FIG. 3, after the client device associates with the network device (S304), then the second client device is identified (S306). For example, with reference to FIG. 2A, the second client device may be client device 206. Client device 206 may associate with gateway device 210 in a manner similar to client device 208 discussed above, or by any known manner. Once associated, network controller 424 of gateway device 210 will add client device 206 to the host table, thus identifying client device 206.

Returning to FIG. 3, after the second client device is identified (S306), then the third client device is identified (S308). For example, with reference to FIG. 2A, the third client device may be security camera 105. Security camera 105 may associate with gateway device 210 by any known manner. Once associated, network controller 424 of gateway device 210 will add security camera 105 to the host table, thus identifying security camera 105. This process of identifying devices may continue as long as devices are associated with gateway device 210.

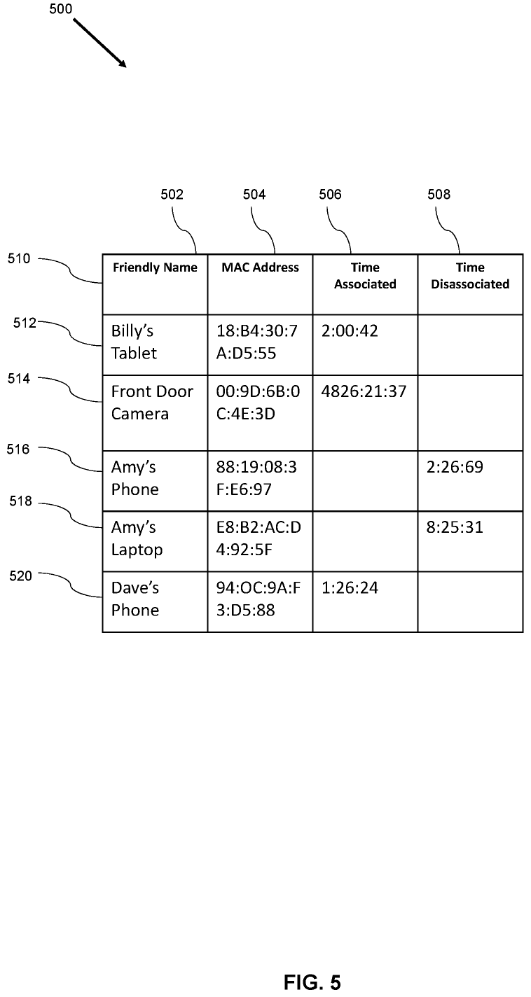

Returning to FIG. 3, after the third client device is identified (S308), a monitored device list is created based on the host table (S310). This will be described in greater detail with reference to FIGS. 2A and 5.

FIG. 5 illustrates a non-limiting example of a host table 500 stored in a Wi-Fi network device.

As shown in the figure, host table 500 includes a friendly name column 502, a MAC address column 504, a time associated column 506, a time disassociated column 508, a heading row 510, a row 512, a row 514, a row 516, a row 518, and a row 520. Host table 500 is merely a representation of a data structure created by network controller 424 and stored within memory 430.

Friendly name column 502 lists a friendly name that a user of client device 208 has given to each respective device in the network that is associated with the Wi-Fi network device. MAC address column 504 lists the MAC address associated with each respective device in the network that is associated with the Wi-Fi network device. Time associated column 506 lists the association period of time that each respective device in the network that is associated with the Wi-Fi network device has been associated with the Wi-Fi network device. Time disassociated column 508 lists the disassociation period of time that each respective device in the network that is was once associated with the Wi-Fi network device but is no longer associated with the Wi-Fi network device.

Data in time associated column 506 and data in time disassociated column 508 is client device presence information. In particular, the data in time associated column 506 may be used to indicate how long a client device is present in the home, whereas the data in time disassociated column 508 may be used to indicate how long a client device has been gone from the home.

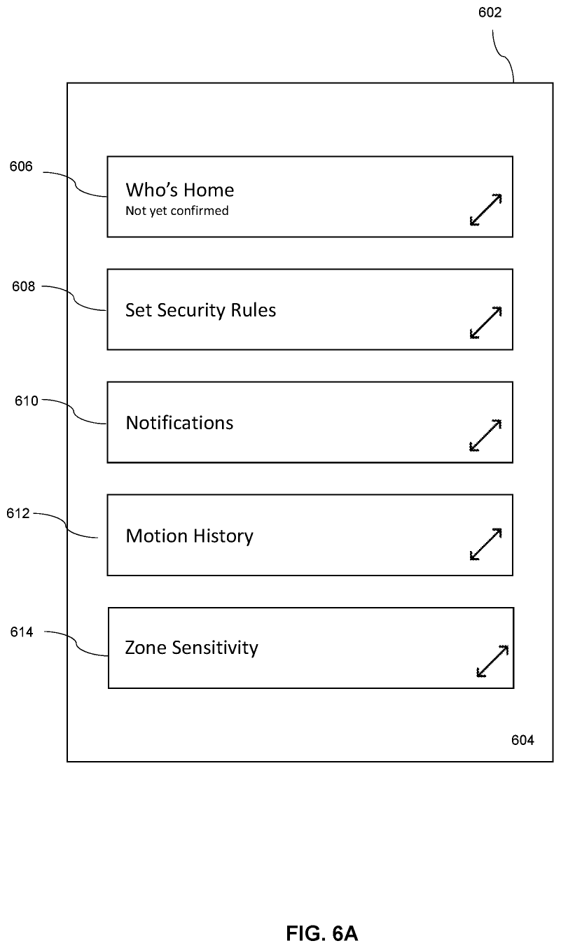

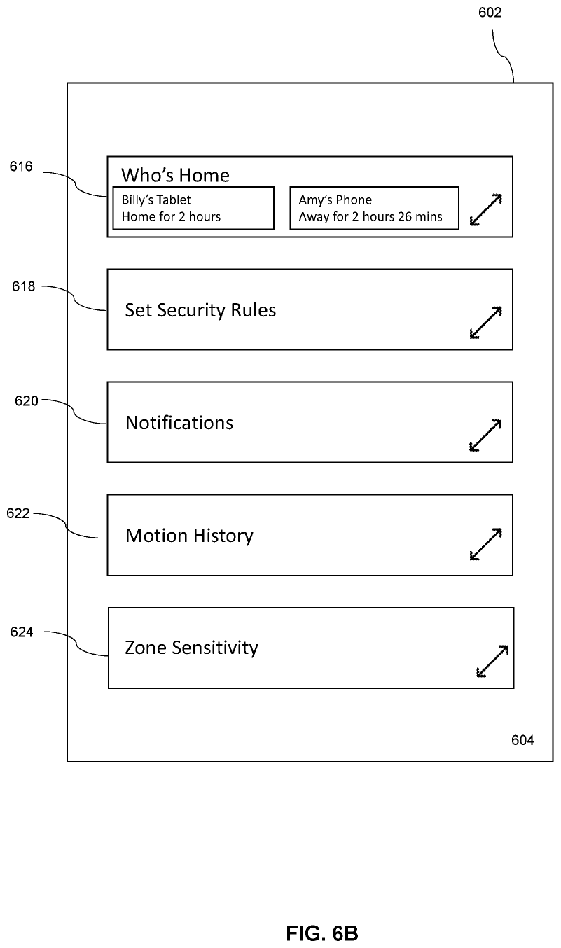

For purposes of discussion, consider the following situation, with reference to FIG. 2A, where client device 208 is being used to monitor the devices currently in the home. Client device 206 and security camera 105 have been identified. For example, as shown in the non-limiting example of host table 500 in FIG. 5, client device 206 may have the MAC address of 88:19:08:3F:E6:97, as shown in column 504, row 516. User 104 may have given a “friendly name” to this device to make it more easily identifiable as Amy's phone, as shown in column 502, row 516. Security camera 105 has also similarly been named Front Door Camera, as shown in column 502, row 514, to make it more easily identifiable. While all devices on this list are connected to gateway device 210, as shown in FIG. 2A, user 104 may only want to monitor Billy's tablet and Amy's phone but not the security camera. A monitored device list may be created to show only the devices user 104 wishes to monitor. This will be described in greater detail with reference to FIGS. 3 and 6A-B.

Returning to FIG. 3, after the monitored device list is created based on the host table (S310), the second client device is added to the monitored devices list (S312). For example, in the situation previously mentioned with reference to FIG. 2A, user 104 may want to monitor client device 206, which had been nicknamed Amy's phone as shown in FIG. 5. As shown in FIG. 4, controller 408 may create the monitored devices list to be stored in memory 414. Controller 408 may additionally modify, add or delete entries within the monitored devices list. A user may then view the monitored devices list by way of display 416.

Returning to FIG. 3, after the second client device is added to the monitored devices list (S312), it is determined if the second client device is associated (S314). For example, as shown in FIG. 4, as described above, if client device 206 is associated with gateway device 210, then network controller 424 will add client device 206 to the host table. Therefore, if client device 206 is listed on the host table, then client device 206 is associated with gateway device 210, and is therefore presumed to be within the residence. On the other hand, if client device 206 is not listed on the host table, then client device 206 is not associated with gateway device 210, and is therefore presumed not to be within the residence. Controller 408 of client device 208 may access the host table within gateway device 210 to determine if client device 206 is associated.

Returning to FIG. 3, if it is determined that the second client device is associated (Y at S314), then an indication that the second client device is associated is provided (S316). For example, returning to FIG. 2A, if client device 206, or Amy's phone, is one of the devices user 104 wishes to monitor, it may be added to a monitored devices list that will be displayed to user 104, a non-limiting example of which could be a light on the gateway device or a visual on the user's client device, etc. A non-limiting example will be described with reference to FIGS. 6A-B.

FIG. 6A illustrates a non-limiting example image 602 displaying a GUI 604 of display 416 at time t₃, in accordance with aspects of the present disclosure.

As shown in the figure, GUI 604 includes user-selectable menu items 606, 608, 610, 612, and 614.

This figure shows a non-limiting example of a display in which the user has yet to select the devices to be added to the monitored device list, as shown with user-selectable menu item 606. Additionally, non-limiting examples of other options to choose from including security rules, notifications, motion history, zone sensitivity, etc. are shown here. An example of a display in which the user has chosen the devices to be added to the monitored devices list will be described in greater detail with reference to FIG. 6B.

FIG. 6B illustrates a non-limiting example image 602 displaying GUI 604 on display 416 at time t₄, in accordance with aspects of the present disclosure.

As shown in the figure, GUI 604 includes user-selectable menu items 616, 618, 620, 622, and 624.

With reference to the previous situation, if user 104, as shown in FIG. 2A, selects client device 206, or Amy's phone as shown in FIG. 5, it would be presented in the user-selectable menu item 616 as illustrated in FIG. 6B. The monitored devices are displayed along with how long each device has been associated, or not associated, with gateway device 210. This is shown to the user as a device being “home” or “away” for X amount of hours and/or minutes. Also, notice that the devices that user 104 did not want to monitor, for example, security camera 105, are not shown here. This display is similar to that of FIG. 6A in that the other user-selectable menu items are also available.

In some embodiments, the user may want to monitor associated devices from outside the home. An example of this will be described in greater detail below with reference to FIG. 2B.

FIG. 2B illustrates communication system 200 in accordance with aspects of the present disclosure at time t₂.

As shown in the figure, communication system 200 is similar to FIG. 2A with the exception of user 104 and client device 208 being outside of the home. Communication system 200 also includes a communication channel 222, a communication channel 224, a communication channel 226, and a communication channel 228.

As shown in the figure, client device 208 is configured to communicate with cellular network 114 via communication channel 222. Cellular network 114 is configured to communicate with Internet 116 via communication channel 224. External server 112 is configured to communicate with gateway device 210 via communication channel 228.

Consider the following situation, user 104 is the parent of user 102, and wants to see if user 102 has returned home from the store. Client device 208 is able to communicate with external server 112 via cellular network 114 and then Internet 116. This then allows client device 208 to communicate with gateway device 210 via external server 112. Client device 208 may then display a screen, as shown in FIG. 6B, showing that Amy's phone has been away for 2 hours and 26 minutes, so she has yet to return home. In this manner, user 104 may quickly and easily determine whether user 102 is home, even though user 104 is not home.

Returning to FIG. 3, if it is determined that the second client device is not associated (N at S314), then algorithm 300 stops (S318).

Returning to FIG. 3, after the indication that the second client device is associated is provided (S316), then it is determined if the client device is still associated (S318).

Returning to FIG. 3, if it is determined that the client device is still associated (Y at S318), then the user is provided an indication that the second client device is associated (return to S316). For example, with the situation previously mentioned with reference to FIG. 6B, a screen may be shown to the user showing that Billy's tablet has been in use for 2 hours, so they are currently associated.

Returning to FIG. 3, if it is determined that the client device is no longer associated (N at S318), then an indication when the client device disassociated is provided (S320). For example, with the situation previously mentioned with reference to FIG. 6B, a screen may be shown to the user showing that Amy's phone has been away for 2 hours and 26 minutes, so they are no longer associated.

Returning to FIG. 3, after an indication when the client device disassociated is provided (S320), then algorithm 300 stops (S322). Therefore in accordance with aspects of the present disclosure, the user of client device 208 will have immediate knowledge of what monitored client devices are associated with the gateway device 210. Accordingly, user of client device 208 will have immediate knowledge of who is present in the residence based on the monitored client devices that are associated with the gateway device. Similarly the user of client device 208 will have immediate knowledge of what monitored client devices have disassociated with gateway device 210. Accordingly, the user of client device 208 will additionally have immediate knowledge of who has left the residence based on the monitored client devices that have disassociated from the gateway device.

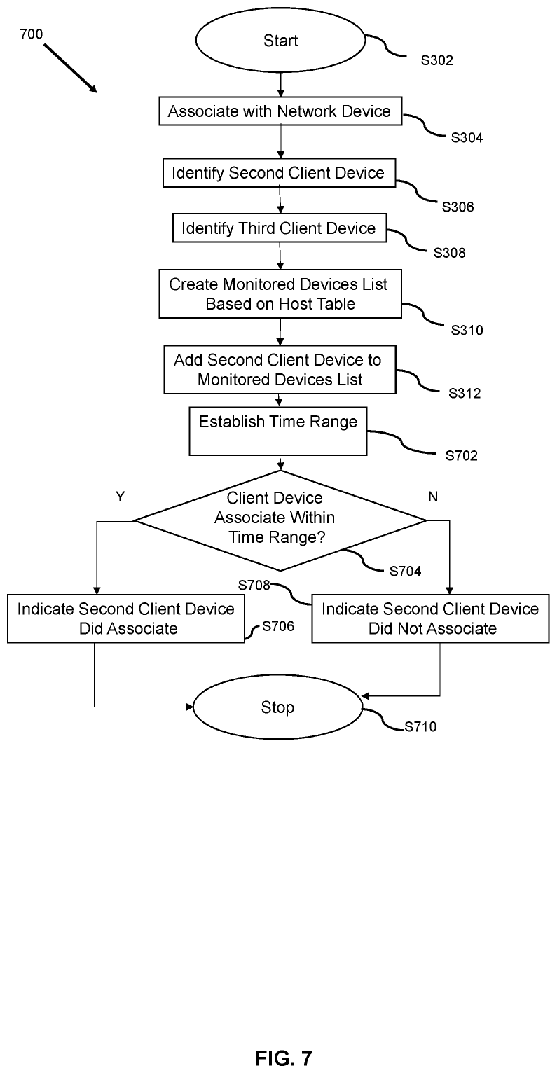

In non-limiting example embodiment discussed above with reference to FIG. 3, the user of client device 208 may know when someone is in residence and/or when that person left the residence. However, in another non-limiting example embodiment, the user of client device 208 may know whether a person has entered the residence within an established time frame. For example, the user of client device 208 may be notified if their child gets home after school (within a time range of 3 to 5) or does not get home during this time. This will be described in greater detail with reference to FIG. 7.

FIG. 7 illustrates another algorithm 700 to be executed by a processor for determining whether a client device has associated with a Wi-Fi network device within an established time range, in accordance with aspects of the present disclosure.

As shown in the figure, algorithm 700 starts (S302), the client device associates with the network device (S304), the second client device is identified (S306), the third client device is identified (S308), a monitored device list is created based on the host table (S310), and the second client device is added to the monitored devices list (S312). These operations may be performed in a manner similar to that discussed above with reference to FIG. 3.

After the second client device is added to the monitored devices list (S312), a time range is established (S702). For example, as shown in FIG. 4, a user may establish a time range by way of controller 408, wherein the time range may then be stored in memory 414.

It should be noted that in this non-limiting example embodiment, a time range is created and is to be associated with a single device to be monitored. For example, a time range of 3:00 PM to 5:00 PM may be created to be associated with a child's phone to assure that the child arrived safely at home after school.

However, in other embodiments, a plurality of time ranges may be created and be associated with a single device to be monitored. For example, one time range of 3:00 PM to 5:00 PM may be created to be associated with a child's phone to assure that the child arrived safely at home after school, whereas another time range of 7:00 AM to 7:30 AM may be created to be associated with the child's phone to assure that the child left the home for school.

Further, in yet other embodiments, a single time range may be created and may be associated with a plurality of devices to be monitored. For example, one time range of 8:00 PM to 4:00 PM may be created to be associated with a plurality of students' respective phones to assure that the children are safe at school.

Returning to FIG. 7, after a time range is established (S702), it is determined whether the client device has associated within the time range (S704). For example, as shown in FIG. 4, as described above with reference to FIG. 3 (S314), if client device 206 is associated with gateway device 210, then network controller 424 will add client device 206 to the host table. The difference here is that controller 408 will additionally determine whether client device 206 was added to the host table within the established time range.

Therefore, if client device 206 is listed on the host table within the established time range, then client device 206 has associated with gateway device 210 within the established time range, and is therefore presumed to have been within the residence within the established time range. On the other hand, if client device 206 is not listed on the host table at all or is not listed in the host table within the established time range (e.g., is now on the host table but was not listed in the host table within the established time range), then client device 206 is not associated with gateway device 210, and is therefore presumed not to be within the residence within the established time range.

Returning to FIG. 7, if it is determined that the client device has associated within the time range (Y at S704), an indication is provided that the client device has associated within the time range (S706). For example, as shown in FIG. 4, controller 408 may instruct display 416 to provide a visual indication, may instruct speaker 418 to provide an audible indication, or a combination of both. Further, in some embodiments the user may input desired indications by way of controller, which will store the indications within memory 414. A non-limiting indication may be an audible sound provided by speaker 418 and a message “Jane has just arrived at home!”

Returning to FIG. 7, after an indication is provided that the client device has associated within the time range (S706), algorithm 700 stops (S710). In this way, a user may easily be notified when someone enters a residence. Further, as shown in FIG. 2B, a user may be notified even when they are themselves not within the residence.

However, if it is determined that the client device has not associated within the time range (N at S704), an indication is provided that the client device did not associate within the time range (S708). For example, as shown in FIG. 4, controller 408 may instruct display 416 to provide a visual indication, may instruct speaker 418 to provide an audible indication, or a combination of both. Further, in some embodiments the user may input desired indications by way of controller, which will store the indications within memory 414. A non-limiting indication may be an audible sound provided by speaker 418 and a message “Jane has not yet arrived at home!”

Returning to FIG. 7, after an indication is provided that the client device did not associate within the time range (S708), algorithm 700 stops (S710). In this way, a user may easily be notified is someone is expected to arrive within a residence, but does not. Further, as shown in FIG. 2B, a user may be notified even when they are themselves not within the residence.

Conventional methods of monitoring devices associated with a gateway may be complex due to the number of devices associated to the gateway. If a user wanted to make a quick check to see if a person's device was in the residence in an emergency situation, the user may be unable to do so in a timely fashion because of the number of devices they have to scroll through. Additionally, this would make it difficult to check quickly if an unfamiliar client device was connected to the gateway device. Also, the user may not know how long the devices have been connected or disconnected to the gateway device. These factors not only pose a threat to security in the user's home but also show flaws in usability that could be corrected to be more user friendly.

In accordance with the present disclosure, the utilization of the network device's client detection mechanism along with a unique client device user interface allows for an easy display of when people are present or absent in a residence as well as how long they have been present or absent from the residence. The network device has the ability to detect when a client device is associated or disassociated from the network. The network device maintains this status in what is known as the host table. In addition to the associated or disassociated status, the network device also maintains the time at which this change in status has last occurred and for how long the device has been associated or disassociated. Each client device is identified within the network device by its MAC address and its host name. The user is able to change this to a more familiar form using their client device. The user may create a “friendly name” for each device. For example, the device with the MAC address of E8:B2:AC:D4:92:5F may be named “Dave's Phone”, and this friendly name is held persistent in the user's account. This allows the user to establish names for each of the client devices within the home network. The user will be offered the ability to configure the home monitoring by selecting the devices they wish to add to the “Who's Home” user interface. The client device will offer a setup screen allowing the user to select the devices to be monitored. This selection screen is not shown. When the user begins home monitoring, the client device will read the status for the client devices connected to the network device on a periodic basis. A device status of active will indicate the associated user is in the residence. At any point, the client device user can bring up the monitoring page to see who is associated with the network device. Various methods and UI interfaces may be used for this status indication. In some embodiments, a UI only shows the associated or at home devices. Other embodiments may show user interfaces with a green or red indicator for each monitored device. However, these are non-limiting examples of just a few options for displaying each monitored device. This monitoring can include a variety of contact devices, motion detectors, and cameras. However, one of the simplest use cases is to know who is associated with the network device and how long they have been associated. This detection and display method resolves this use case without any additional equipment.

One benefit of this invention is the use of the client device associated/disassociated, or home/not home status to provide a simple and straightforward manner to monitor what devices are connected. Additionally, the simple user interface to display if someone is home or away, along with their duration time, allows for easy monitoring. Both allow for increased security and monitoring of who is in the home and what devices are connected to the user's gateway device. Another benefit of this invention is the ability to monitor a residence without having to purchase any additional equipment, since this can all be done with the use of the client device as well as the network device.

The foregoing description of various preferred embodiments have been presented for purposes of illustration and description. It is not intended to be exhaustive or to limit the present disclosure to the precise forms disclosed, and obviously many modifications and variations are possible in light of the above teaching. The example embodiments, as described above, were chosen and described in order to best explain the principles of the present disclosure and its practical application to thereby enable others skilled in the art to best utilize the present disclosure in various embodiments and with various modifications as are suited to the particular use contemplated. It is intended that the scope of the present disclosure be defined by the claims appended hereto.

What is claimed is:

1. A client device for use with a Wi-Fi network device, a second client device and a third client device, the Wi-Fi network device having a host table stored therein, the host table listing the second client device, second client device presence information indicating whether the second client device is currently associated with the Wi-Fi network device, and the third client device, said client device comprising:
a memory; and
a processor configured to execute instructions stored on said memory to cause said client device to:
associate with the Wi-Fi network device;
identify the second client device;
identify the third client device;
create a monitored devices list of client devices associated with the Wi-Fi network device based on the host table;
add the second client device to the monitored devices list;
determine, from the host table, whether the second client device is currently associated with the Wi-Fi network device; and
provide an indication when the second client device is currently associated with the Wi-Fi network device.

2. The client device of claim 1, wherein said processor is configured to execute instructions stored on said memory to cause said client device additionally to indicate, in a state where the second client device is associated with the Wi-Fi network device, time information related to when the second client device associated with the Wi-Fi network device.

3. The client device of claim 1, wherein said processor is configured to execute instructions stored on said memory to cause said client device additionally to indicate, in a state where the second client device is not associated with the Wi-Fi network device, time information related to when the second client device disassociated with the Wi-Fi network device.

4. The client device of claim 1, wherein said processor is configured to execute instructions stored on said memory to cause said client device additionally to:
not add the third client device to the monitored devices list;
not determine whether the third client device is currently associated with the Wi-Fi network device; and
not provide an indication when the third client device is currently associated with the Wi-Fi network device.

5. The client device of claim 1, wherein said processor is configured to execute instructions stored on said memory to cause said client device additionally to:
establish a time range;
associate the second client device with the time range; and
determine, from the host table, whether the second client device has associated with the Wi-Fi network device within the time range.

6. The client device of claim 5, wherein said processor is configured to execute instructions stored on said memory to cause said client device additionally to provide an indication when the second client device has not associated with the Wi-Fi network device within the time range.

7. A method of using a client device with a Wi-Fi network device, a second client device and a third client device, the Wi-Fi network device having a host table stored therein, the host table listing the second client device, second client device presence information indicating whether the second client device is currently associated with the Wi-Fi network device, and the third client device, said method comprising:
associating, via a processor configured to execute instructions stored on a memory, with the Wi-Fi network device;
identifying, via the processor, the second client device;
identifying, via the processor, the third client device;
creating, via the processor, a monitored devices list of client devices associated with the Wi-Fi network device based on the host table;
adding, via the processor, the second client device to the monitored devices list;
determining, via the processor and from the host table, whether the second client device is currently associated with the Wi-Fi network device; and
providing, via the processor, an indication when the second client device is currently associated with the Wi-Fi network device.

8. The method of claim 7, further comprising indicating, via the processor and in a state where the second client device is associated with the Wi-Fi network device, time information related to when the second client device associated with the Wi-Fi network device.

9. The method of claim 7, further comprising indicating, via the processor and in a state where the second client device is not associated with the Wi-Fi network device, time information related to when the second client device disassociated with the Wi-Fi network device.

10. The method of claim 7, further comprising:
not adding, via the processor, the third client device to the monitored devices list;
not determining, via the processor, whether the third client device is currently associated with the Wi-Fi network device; and
not providing, via the processor, an indication when the third client device is currently associated with the Wi-Fi network device.

11. The method of claim 7, further comprising:
establishing, via the processor, a time range;
associating, via the processor, the second client device with the time range; and
determining, via the processor and from the host table, whether the second client device has associated with the Wi-Fi network device within the time range.

12. The method of claim 11, further comprising providing, via the processor, an indication when the second client device has not associated with the Wi-Fi network device within the time range.

13. A non-transitory, computer-readable media having computer-readable instructions stored thereon, the computer-readable instructions being capable of being read by a processor in a client device for use with a Wi-Fi network device, a second client device and a third client device, the Wi-Fi network device having a host table stored therein, the host table listing the second client device, second client device presence information indicating whether the second client device is currently associated with the Wi-Fi network device, and the third client device wherein the computer-readable instructions are capable of instructing the processor to perform the method comprising:
associating, via a processor configured to execute instructions stored on a memory, with the Wi-Fi network device;
identifying, via the processor, the second client device;
identifying, via the processor, the third client device;
creating, via the processor, a monitored devices list of client devices associated with the Wi-Fi network device based on the host table;
adding, via the processor, the second client device to the monitored devices list;
determining, via the processor and from the host table, whether the second client device is currently associated with the Wi-Fi network device; and
providing, via the processor, an indication when the second client device is currently associated with the Wi-Fi network device.

14. The non-transitory, computer-readable media of claim 13, wherein the computer-readable instructions are capable of instructing the processor to perform the method further comprising indicating, via the processor and in a state where the second client device is associated with the Wi-Fi network device, time information related to when the second client device associated with the Wi-Fi network device.

15. The non-transitory, computer-readable media of claim 13, wherein the computer-readable instructions are capable of instructing the processor to perform the method further comprising indicating, via the processor and in a state where the second client device is not associated with the Wi-Fi network device, time information related to when the second client device disassociated with the Wi-Fi network device.

16. The non-transitory, computer-readable media of claim 13, wherein the computer-readable instructions are capable of instructing the processor to perform the method further comprising:
not adding, via the processor, the third client device to the monitored devices list;
not determining, via the processor, whether the third client device is currently associated with the Wi-Fi network device; and
not providing, via the processor, an indication when the third client device is currently associated with the Wi-Fi network device.

17. The non-transitory, computer-readable media of claim 13, wherein the computer-readable instructions are capable of instructing the processor to perform the method further comprising:
establishing, via the processor, a time range;
associating, via the processor, the second client device with the time range; and
determining, via the processor and from the host table, whether the second client device has associated with the Wi-Fi network device within the time range.

18. The non-transitory, computer-readable media of claim 17, wherein the computer-readable instructions are capable of instructing the processor to perform the method further comprising providing, via the processor, an indication when the second client device has not associated with the Wi-Fi network device within the time range.
